(19) United States
(12) Patent Application Publication
(10) Pub. No.: US 2026/0062227 A1
(43) Pub. Date: Mar. 5, 2026

(54) REMOVABLE PRIMARY CLEANER

(71) Applicant: ASGCO Manufacturing, Inc., Nazareth, PA (US)

(72) Inventors: Andrew M. COLLIER, Allentown, PA (US); Ezra T. NEFF, Walnutport, PA (US)

(21) Appl. No.: 19/312,701

(22) Filed: Aug. 28, 2025

Related U.S. Application Data
(60) Provisional application No. 63/688,954, filed on Aug. 30, 2024.

(51) Int. Cl. B65G 45/12

(52) U.S. Cl. CPC B65G 45/12

(57) ABSTRACT

A conveyor belt primary cleaning blade and device that permits a pair of cleaning blades to be releasably secured to a mounting tube without the need for a separate cartridge. The blade includes an aluminum extrusion that is embedded in the bottom portion of the urethane blade when the blade is formed. The aluminum extrusion is formed of a pair of opposing sidewalls connected at their upper ends by a top wall, so that the lower end of the element is open. Indents are formed in the opposing sidewalls at both ends of the extrusion and are used to engage a groove track in a keeper element secured to a mounting tube. The extrusion is slid over the keeper causing the indents to releasably lock into the grooves.

### CROSS-REFERENCE TO RELATED APPLICATIONS

This non-provisional application claims the benefit under 35 U.S.C. § 119 (e) of Application Ser. No. 63/688,954 filed on Aug. 30, 2024 entitled REMOVABLE PRIMARY CLEANER and whose entire disclosure is incorporated by reference herein.

### BACKGROUND OF THE INVENTION

The present invention relates generally to conveyor belt cleaners and more particularly, to an apparatus and method for removing and replacing cleaning blades more easily and securely.

Conveyor belts are used in a variety of industries to transport materials from one place to another. Generally, materials are deposited at one end of a conveyor and are transported to the other end, where they are discharged or otherwise removed from the conveyor belt. Cleaning the conveyor belts is accomplished with primary cleaning blades that are typically installed on a mounting tube and having a free edge that rides against or closely adjacent the conveyor belt transporting the materials.

In many scenarios, the primary cleaning blades and mounting tubes are situated inside a chute enclosure. When it becomes necessary to replace the blade, an access door on one side of the chute is opened and the cleaning blade is pulled off the mounting tube and out of the chute through the access door. See FIGS. 1A-1B. Although these figures actually depict “secondary” cleaning blades,” they are being used simply to demonstrate the removable feature used with some conventional primary cleaning blades and the deficiencies associated therewith. As can be seen in FIG. 1A, the cleaning blade/cartridge assembly is slid completely over the mounting tube and the right end of the assembly is engaged over a stop pin. To replace the blade, an access door (or opening, neither shown) to the chute is opened and the cleaning blade/cartridge assembly is pulled off the mounting tube, by sliding the blade/cartridge to the left. However, there are several disadvantages to that design. Firstly, use of a cartridge adds significant weight to the cleaning blade itself. Secondly, if the right end of the cleaning blade/cartridge assembly were slid slightly to the left (and thus disengaged from the stop pin), any rotation of the mounting tube would cause the right end of the cleaning blade/cartridge assembly to detach from the mounting tube.

While the devices disclosed in the aforementioned discussion may be generally suitable for their intended purposes, these devices have the indicated deficiencies. Thus, there remains a need for a cleaning blade that can be releasably secured to the mounting tube, easily removed and easily replaced while keeping the weight of the blade reduced and while preventing the blade from displacing away from the mounting tube when the tube is rotated.

All references cited herein are incorporated herein by reference in their entireties.

### BRIEF SUMMARY OF THE INVENTION

A conveyor belt primary cleaning blade configured for installation on a mounting tube is disclosed. The primary cleaning blade comprises: a blade body having a cleaning edge and a bottom portion opposite the cleaning edge, wherein the bottom portion comprises an extrusion that is embedded within the body, wherein the extrusion comprises a pair of opposing sidewalls having upper ends connected together by a top wall, wherein the extrusion has an open bottom end, and wherein the open bottom end is coincident with a bottom edge of the blade body; and wherein the extrusion runs a length of the blade body and has a first end and a second end, and wherein the first end comprises an indent in each sidewall to form a first pair of opposing indents at the first end and a second pair of opposing indents at the second end.

A conveyor belt primary cleaning blade device configured for installation on a conveyor system is disclosed. The primary cleaning blade device comprises: a pair of blade bodies, each blade body having a cleaning edge and a bottom portion opposite the cleaning edge, wherein the bottom portion comprises an extrusion that is embedded within the body, wherein the extrusion comprises a pair of opposing sidewalls having upper ends connected together by a top wall, wherein the extrusion has an open bottom end, wherein the open bottom end is coincident with a bottom edge of the blade body; wherein the extrusion runs a length of the blade body and has a first end and a second end, wherein the first end comprises an indent in each sidewall to form a first pair of opposing indents at the first end and a second pair of opposing indents at the second end; a mounting tube having a connecting element thereon, wherein the connecting element comprises an upstanding wall having a pair of groove tracks machined within the upstanding wall; and wherein each of the blade bodies is releasably secured to a respective track by any pair of said opposing indents being engaged within the groove track when the open bottom end of the extrusion is slid over the groove track.

A method of forming a conveyor belt primary cleaning blade configured for installation on a mounting tube is disclosed. The method comprises: forming an extrusion comprising a pair of opposing sidewalls having upper ends connected together by a top wall and an open bottom end and wherein the extrusion has first and second ends and wherein an indent is embedded in each sidewall to form a first pair of opposing indents at the first end and a second pair of opposing indents at the second end; inserting the extrusion into a mold for forming a blade body having a cleaning edge and a bottom portion opposite the cleaning edge; and pouring a urethane into the mold to form the cleaning blade with the extrusion being formed integral to the bottom portion such that the open bottom end is coincident with a bottom edge of the blade body when the urethane is cured.

A method of forming a conveyor belt primary cleaning blade device configured for installation on a conveyor belt system is disclosed. The method comprises: forming an extrusion comprising a pair of opposing sidewalls having upper ends connected together by a top wall and an open bottom end and wherein the extrusion has first and second ends and wherein an indent is embedded in each sidewall to form a first pair of opposing indents at the first end and a second pair of indents at the second end; inserting the extrusion into a mold for forming a blade body having a cleaning edge and a bottom portion opposite the cleaning edge; pouring a urethane into the mold to form the cleaning blade with the extrusion being formed integral to the bottom portion such that the open bottom end is coincident with a bottom edge of the blade body when the urethane is cured; machining a groove track in an element that is fixed to a mounting tube configured for mounting within a conveyor belt system; and sliding the open bottom end of the extrusion over said element such that any pair of the opposing indents are engaged within the groove track to releasably secure the blade body to the mounting tube.

A method of forming a conveyor belt primary cleaning blade device configured for installation on a conveyor belt system is disclosed. The method comprises: forming an extrusion comprising a pair of opposing sidewalls having upper ends connected together by a top wall and an open bottom end and wherein the extrusion has first and second ends and wherein an indent is embedded in each sidewall to form a first pair of opposing indents at the first end and a second pair of indents at the second end; inserting the extrusion into a mold for forming a blade body having a cleaning edge and a bottom portion opposite the cleaning edge; pouring a urethane into the mold to form the cleaning blade with the extrusion being formed integral to the bottom portion such that the open bottom end is coincident with a bottom edge of the blade body when the urethane is cured; machining a groove track in an element that is fixed to a mounting tube configured for mounting within a conveyor belt system; and applying a downward force on the blade body causing the open bottom end of said extrusion to press over said aluminum element such that any pair of said opposing indents are engaged with said groove track to releasably secure said blade body to said mounting tube.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A depicts a removable prior art secondary cleaning blade/cartridge assembly positioned on a mounting tube;

FIG. 1B depicts the prior art secondary cleaning blade/cartridge assembly of FIG. 1A slid slightly to the left;

FIG. 2 depicts two of the inventive replaceable primary cleaner blades releasably secured onto a removable primary cleaner mounting tube in their operative state;

FIG. 3A is an isometric view of the removable primary cleaner mounting tube including an engagement track referred to as a “keeper” secured thereto;

FIG. 3B is a side view of the removable primary cleaner mounting tube;

FIG. 3C is a top view of the removable primary cleaner mounting tube also showing the slots in the keeper portion;

FIG. 3D is an enlarged, partial top view of one of the slots of the keeper;

FIG. 3E is an end view of the removable primary cleaner mounting tube;

FIG. 4A is an isometric view of the aluminum extrusion that forms a blade connector;

FIG. 4B is a top view of the aluminum extrusion of FIG. 4A;

FIG. 4C is a side view of the aluminum extrusion of FIG. 4A;

FIG. 4D is an enlarged end view of the aluminum extrusion of FIG. 4A;

FIG. 5A is an isometric view of one of the inventive replaceable primary cleaner blade with the pivoting handle on the outer end of the blade omitted;

FIG. 5B is a front view of the inventive replaceable primary cleaner blade with the pivoting handle on the outer end of the blade omitted;

FIG. 5C is a side view of the inventive replaceable primary cleaner blade;

FIG. 5D is a partial side view of the inventive replaceable primary cleaner blade showing the blade connector;

FIG. 6 is a cross-sectional view of the inventive replaceable primary cleaner blade releasably coupled to the keeper taken along line 6-6 of FIG. 2;

FIG. 6A is view of the inventive replaceable primary cleaner blade (whose outline is only shown), taken from the blade body end opposite to the end of the blade body of FIG. 6, and showing how the blade body can be pulled upward to disengage from the keeper or can be pushed downward to releasably secure the blade body to the keeper;

FIG. 6B depicts the blade body (in outline only) of the present invention is releasably secured to the keeper following the downward force applied as discussed regarding FIG. 6A;

FIG. 7A depicts two primary blades installed on the keeper/mounting tube of the present invention and ready for operation;

FIG. 7B is an end of one of the primary blades of FIG. 7A and showing the handle grip resting on the mounting tube;

FIG. 7C depicts the handles being grasped by an operator (not shown) and tilted to begin the removal process through the opened access doors both sides of the conveyor system;

FIG. 7D is an end view of one of the primary blades of FIG. 7C and showing the handle grip position with the handle pivoted upward;

FIG. 7E depicts the further sequence as the far ends of each blade emerges from their respective access doors; and

FIG. 7F depicts each of the blades fully disengaged from the keeper and being pulled straight through the opened access doors.

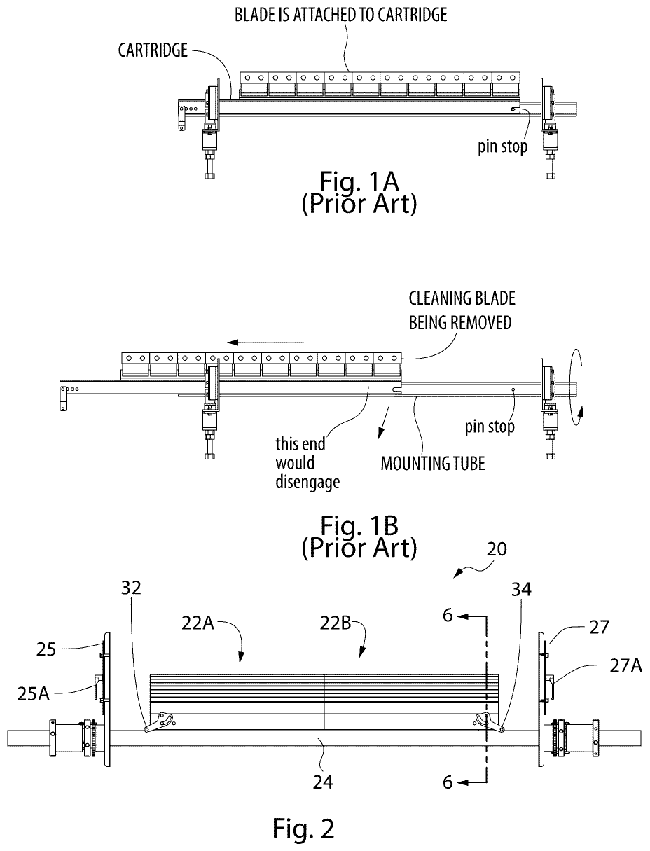

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

FIG. 2 depicts the present invention 20 which includes a pair of removable primary cleaner blades 22A/22B that are releasably secured to a mounting tube 24 which is located inside a housing (e.g. a chute, not shown) having access doors 25 and 27 on opposite sides thereof and corresponding handles 25A and 27A to open and close these doors 25 and 27. Based on the inventive design of these blades 22A/22B, they can be easily removed and replaced due to a unique blade connector 28 and interface with the mounting tube 24, which is discussed in detail below. Blade 22A is considered associated with the “left” side of the present invention 20 by way of example only and Blade 22B is considered associated with the “right” side of the present invention 20 by way of example only.

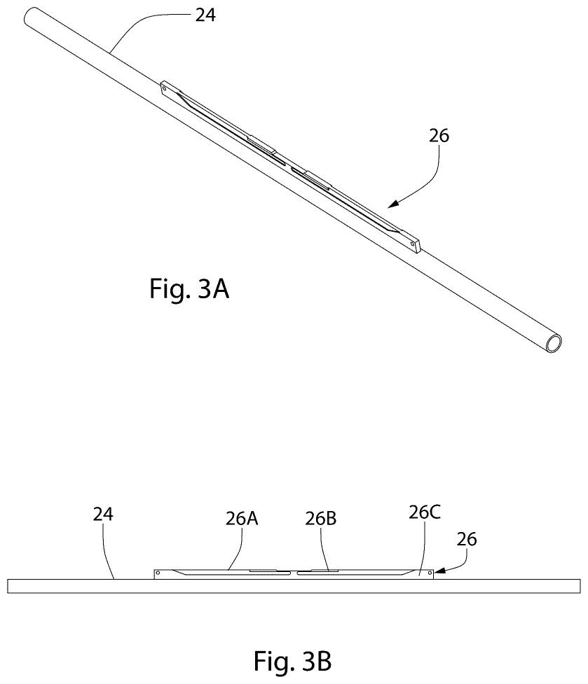

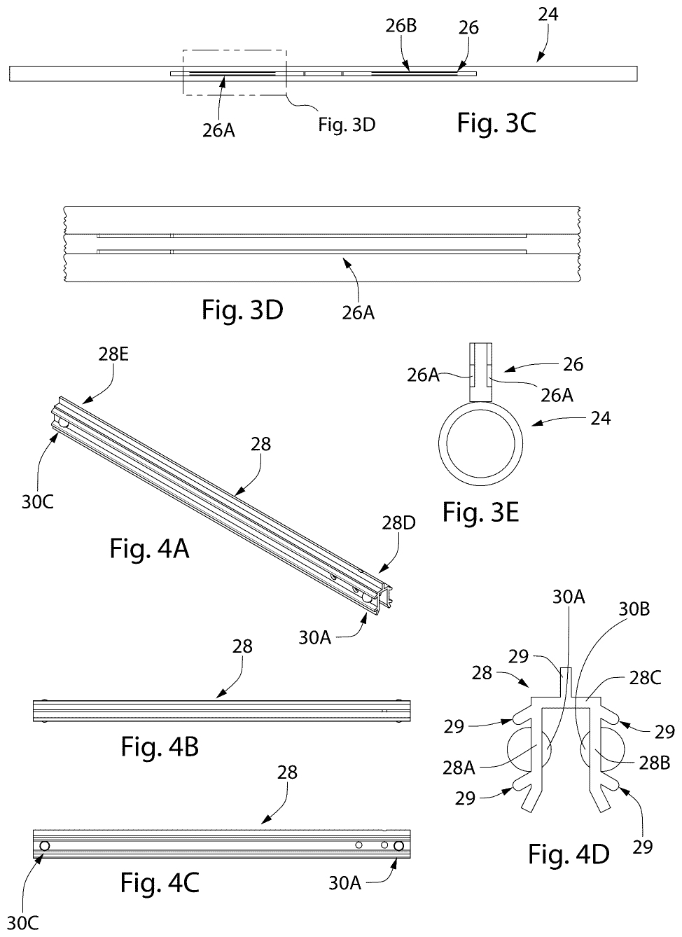

Unlike conventional primary cleaning blades that are attached to cartridges, the blades 22A and 22B have an “integral cartridge” that forms the blade connector 28. As shown most clearly in FIGS. 3A-3E, the mounting tube 24 comprises an element 26 secured (e.g., welded) thereto, hereinafter referred to a “keeper 26”. The keeper 26 comprises a pair of machined groove tracks 26A and 26B formed into an upstanding wall 26C and which are configured for coupling with the blade connector 28 of a respective blade 22A and 22B, as will be discussed in detail below. FIG. 3D is an enlarged partial view of one of these tracks 26A.

As shown in FIGS. 4A-4D, an aluminum extrusion 28 is formed having an open rectangular cross-section (FIG. 4D) with spines 29. As shown most clearly in FIG. 4D, the extrusion 28 comprises a pair of opposing sidewalls 28A and 28B that are connected by an upper top wall 28C. In addition, at a first end 28D (FIG. 4A) of the extrusion 28, indents 30A/30B are formed on the inside of the pair of opposing sidewalls 28A and 28B; as will be discussed later, these indents 30A/30B releasably secure the blade to the keeper 26. It should be understood that there are a wide variety of ways of making these indents 30A/30B within the inner side of the opposing sidewalls 28A/28B. By way of example only, one way of accomplishing this is to embed steel balls (e.g., ¾″ in diameter) in those sidewalls 28A/28B, as shown in FIGS. 4A, 4C and etc. Alternatively, other exemplary methods of forming the indents 30A/30B is to form the inner surface of the sidewalls 28A/28B to be a cylinder or a square bar, etc. However, in the broadest scope of the invention 20, these indents 30A/30B are not, in any way, limited to the use of steel balls, cylinders, square bars, etc. Furthermore, to permit a blade to be connected to either one of the machined groove tracks 26A/26B in the keeper 26, similar indents (only one of which, 30C) are provided at the other end 28E of the aluminum extrusion 28, again on the opposing sidewalls 28A/28B. As will be discussed below, the aluminum extrusion 28 forms the “integral cartridge” or blade connector.

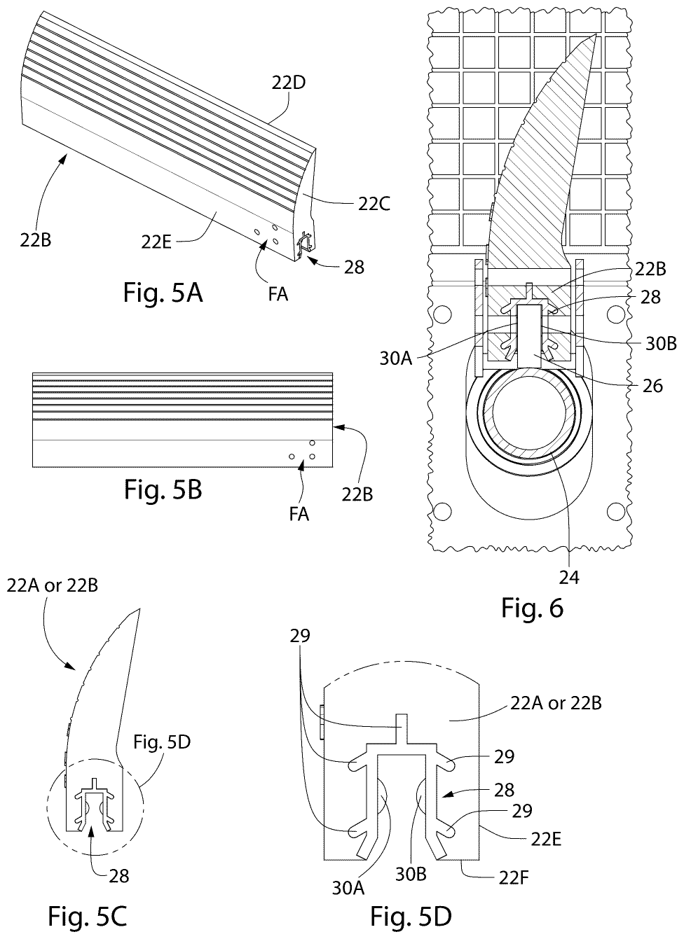

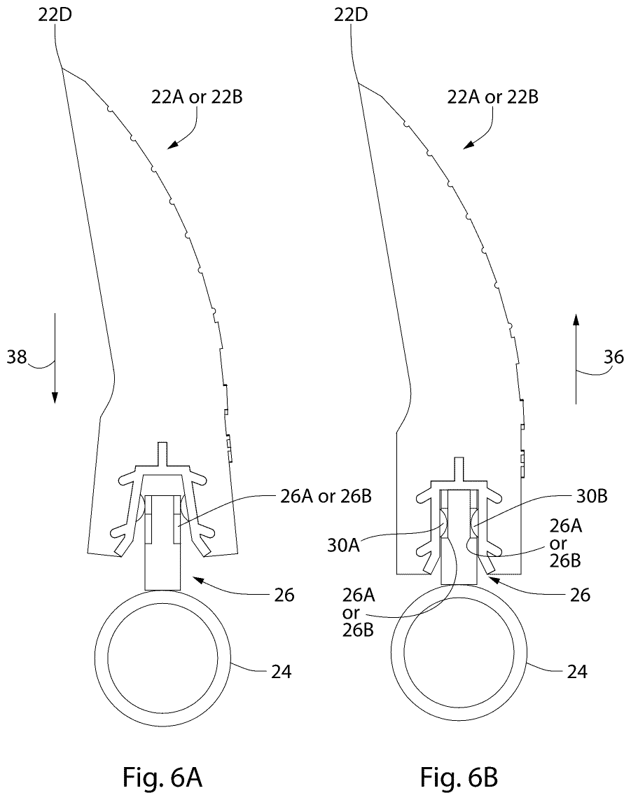

Each removable primary cleaning blade 22A or 22B (FIG. 5B) is formed of a urethane material that is poured into a mold (not shown) but, unique to these blades, the aluminum extrusion 28 is included in that mold. When the urethane cures and hardens, each blade comprises a blade body 22C, a cleaning edge 22D and an opposite bottom portion 22E having a bottom edge 22F (FIG. 5D). In addition, as shown in FIGS. 5A, 5C and 5D, the bottom portion 22E of the blades 22A/22B are formed with the aluminum extrusion 28 embedded therein. The spines 29 mentioned earlier facilitate in locking the aluminum extrusion 28 within the bottom portion 22E of each blade 22A/22B. Thus, the aluminum extrusion 28 forms the blade connector 28 as is discussed below. FIG. 6 depicts the blade body 22A22B releasably coupled to the keeper 26.

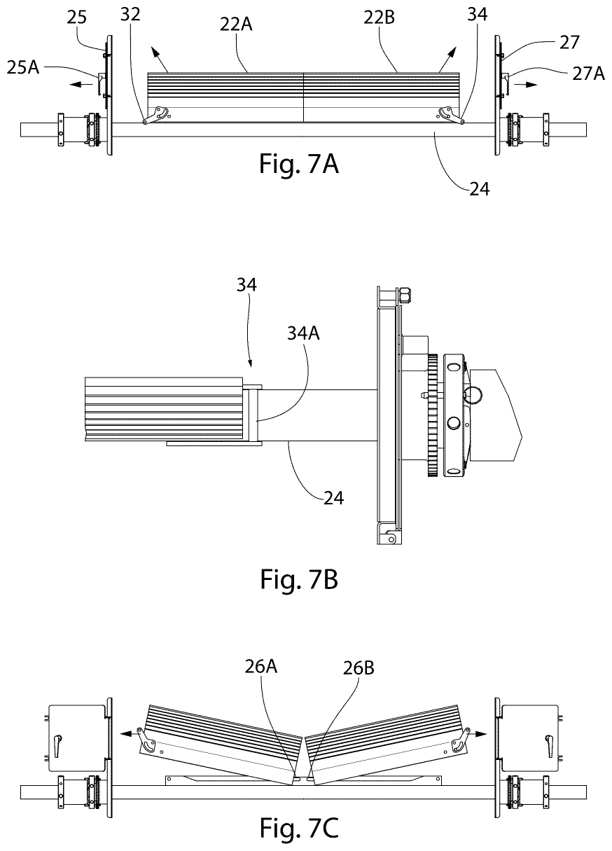

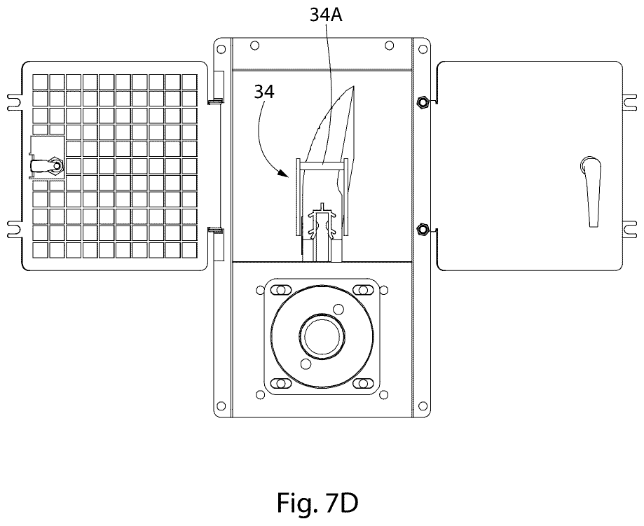

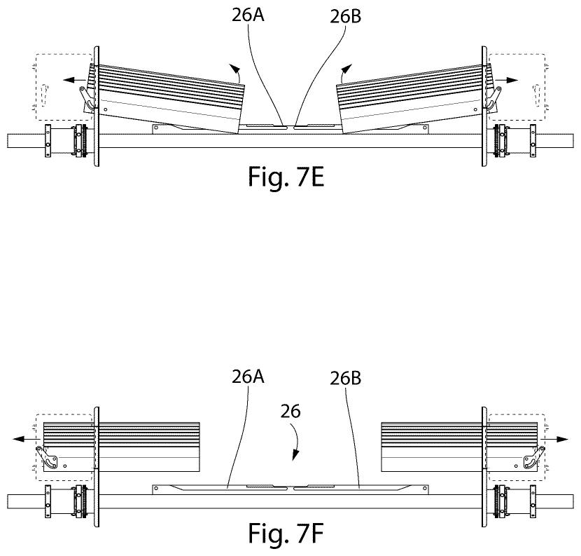

To couple the removable primary cleaning blades 22A and 22B to the keeper 26, one end of blade 22A (the following discussion applies to blade 22A with the understanding that the same applies to blade 22B) is tilted to align the indents (e.g., 30A and 30B) within the angled portion (see FIG. 3A) of the machined groove track 26A. As the blade 22A is sightly moved downward and then toward the center of the keeper 26, the two indents 30A/30B act to releasably “lock” or “secure” the blade 22A to the keeper 26, thereby forming a retention system; conversely, if the other end of the blade 22A is being engaged with the other machined groove track 26B, the two indents (30C and its corresponding indent across therefrom) at the other end of the aluminum extrusion 28 are used to releasably secure the blade 22A to the keeper 26. In FIG. 6, the indents 30A and 30B can be seen positioned inside the track 26A of the keeper 26. By installing each blade 22A and 22B from respective sides of the mounting tube 24, the blades 22A/22B can be pushed towards the center of the keeper 26 until the indents (30A/30B, or 30C and its corresponding indent) on the one end of the blade 22A/22B impact the end of its respective track. When that occurs, the two blades 22A and 22B are abutting one another, as shown in FIGS. 2 and 7A.

It should be noted that the outer ends of both blades 22A and 22B comprise pivoting handles 32 and 34 (compare FIGS. 7A and 7C) that are fastened to the bottom portion 22E (FIGS. 5A-5B depict the bottom portion 22E of blade 22B showing the fastener apertures FA for the handle 34; it being understood that attachment apertures are also present in the bottom edge 22E of the outer end of blade 22A). Each handle has a handle grip, only one 34A of which is shown in FIG. 7B, it being understood that handle 32 has a corresponding handle grip). With the blades 22A/22B installed on the keeper 26, the handles 32/34 rest on the mounting tube 24 (FIGS. 7A-7B); this pivoting design of these handles 32/34 maintains these handles with a low profile to avoid interfering with blade cleaning during conveyor operation.

Conversely, to remove the primary cleaning blades 22A and 22B, the sequence in FIGS. 7B, 7E and 7F is followed. In particular, the access doors 25/27 are opened using their respective handles 25A/27A. Operators then reach in and grasp the handle grips (only one 34A of which is shown on the outer end of blade 22B) of respective handles 32 and 34 of blades 22A and 22B. By grasping the handle grips, the handles 32/34 pivot upward (compare FIG. 7B where the handle 34 rests on the mounting tube 24 to the upwardly pivoted position shown in FIG. 7D). The operators pull up on the handle grips of the handles 32/34 as shown by the arrows in FIGS. 7C and 7E) and they pull the blades outward (in the direction of the arrows shown in FIGS. 7C and 7E-7F). As that occurs, the indents 30A-30B (or 30C and its corresponding indent across therefrom, depending on which side of the blades 22A/22B were previously engaged with the machined groove tracks 26A/26B) ride inside the machined groove tracks 26A/26B and then upward slightly on the angled ends thereof (FIGS. 7C and 7E). The blades 22A/22B are pulled further outward eventually disengaging the indents 30A-30C from the tracks 26A/26B and the operators can then remove the blades 22A/22B from the housing (FIG. 7F).

FIGS. 6A-6B depict another feature of the present invention. As discussed previously, the preferred method of releasably securing the blades 22A/22B to the keeper 26 is via the use of the alignment of indents 30A/30B within the angled portion of the machined groove track 26A/26B. Alternatively, if for any reason, removal or insertion of the blades 22A/22B is hindered (e.g., access door 25 or 27 cannot be opened, etc.), there is another way to remove or insert the blades 22A/22B. In particular, due to “spring-back” in the aluminum keeper 26 (aluminum having a higher “spring-back” rate compared to other metals), the operator can pull upward (i.e., upward force 36 as shown in FIG. 6B) on the blade 22A/22B which “frees” the indents 30A/30B from the grooves 26A/26B, thereby disengaging the blades 22A/22B from the keeper 26. Conversely, if insertion of the blades 22A/22B is hindered, the operator can apply a downward force 38 (FIG. 6A) to press over the keeper 26 and thereby insert the indents 30A/30B into the groves 26A/26B. Again, the application of such upward 36 and downward 38 forces are the less preferred methods of removing or inserting, respectively, the blades 22A/22B, but those alternative methods are available in the present invention 20.

In view of the foregoing, this unique design provides several advantages over conventional primary cleaning blades. Conventional blade cartridges omit a means of retaining the blade cartridge so that the blade can be installed in any position other than vertical. Furthermore, use of the conventional cartridge results in adding additional weight to the blade apparatus. This can be problematic where mines in certain jurisdictions (e.g., South America) limit conveyor cleaning components to a maximum weight. In contrast, the embedded blade connector 28 of the present invention avoids the weight of a blade and a separate cartridge.

### REFERENCE CHARACTERS

FA fastener apertures
20 present invention
22A left primary cleaning blade
22B right primary cleaning blade
22C blade body
22D cleaning edge
22E bottom portion
22F bottom edge
24 mounting tube
25 left access door of housing
25A handle for left access door
26 aluminum keeper
26A left machined groove track
26B right machined groove track
26C upstanding wall
27 right access door of housing
27A handle for right access door
28 aluminum extrusion (aka blade connector)
28A one opposing sidewall
28C upper top wall
28D first end of extrusion
28E second end of extrusion
28B other opposing sidewall
29 spines
30A first indent at first end of extrusion
30B second indent at first end of extrusion
30C first indent at second end of extrusion
32 pivoting handle on blade body 22A
34 pivoting handle on blade body 22B
34A handle grip of handle 34
36 upward force to disengage blade body from keeper
38 downward force to engage blade body to keeper

While the invention has been described in detail and with reference to specific examples thereof, it will be apparent to one skilled in the art that various changes and modifications can be made therein without departing from the spirit and scope thereof.

What is claimed is:

1. A conveyor belt primary cleaning blade configured for installation on a mounting tube, said primary cleaning blade comprising:
a blade body having a cleaning edge and a bottom portion opposite said cleaning edge, said bottom portion comprising an extrusion that is embedded within said body, said extrusion comprising a pair of opposing sidewalls having upper ends connected together by a top wall, said extrusion having an open bottom end, said open bottom end being coincident with a bottom edge of said blade body;
said extrusion running a length of said blade body and having a first end and a second end, said first end comprising an indent in each sidewall to form a first pair of opposing indents at said first end and a second pair of opposing indents at said second end.

2. The conveyor belt primary cleaning blade of claim 1 wherein said extrusion comprises aluminum.

3. The conveyor belt primary cleaning blade of claim 1 wherein said blade body comprises urethane.

4. The conveyor belt primary cleaning blade of claim 1 wherein each of said indents is formed by embedding a steel ball in a corresponding sidewall.

5. The conveyor belt primary cleaning blade of claim 1 comprising a pivoting handle located on said bottom portion at an outer end of said blade body.

6. A conveyor belt primary cleaning blade device configured for installation on a conveyor belt system, said primary cleaning blade device comprising:
a pair of blade bodies, each blade body having a cleaning edge and a bottom portion opposite said cleaning edge, said bottom portion comprising an extrusion that is embedded within said body, said extrusion comprising a pair of opposing sidewalls having upper ends connected together by a top wall, said extrusion having an open bottom end, said open bottom end being coincident with a bottom edge of said blade body;
said extrusion running a length of said blade body and having a first end and a second end, said first end comprising an indent in each sidewall to form a first pair of opposing indents at said first end and a second pair of opposing indents at said second end;
a mounting tube having a connecting element thereon, said connecting element comprising an upstanding wall having a pair of groove tracks machined within said upstanding wall; and
each of said blade bodies are releasably secured to a respective track by any pair of said opposing indents being engaged within said groove track when said open bottom end of said extrusion is slid over said groove track.

7. The conveyor belt primary cleaning blade device of claim 6 wherein said extrusion comprises aluminum.

8. The conveyor belt primary cleaning blade device of claim 6 wherein each of said blade bodies comprises urethane.

9. The conveyor belt primary cleaning blade device of claim 6 wherein each of said indents is formed by embedding a steel ball in each of sidewalls.

10. The conveyor belt primary cleaning blade device of claim 6 comprising a pivoting handle located on said bottom portion at an outer end of each of said blade bodies.

11. A method of forming a conveyor belt primary cleaning blade configured for installation on a mounting tube, said method comprising:
forming an extrusion comprising a pair of opposing sidewalls having upper ends connected together by a top wall and an open bottom end and wherein said extrusion has first and second ends and wherein an indent is embedded in each sidewall to form a first pair of opposing indents at said first end and a second pair of opposing indents at said second end;
inserting said extrusion into a mold for forming a blade body having a cleaning edge and a bottom portion opposite said cleaning edge; and
pouring a urethane into said mold to form said cleaning blade with said extrusion being formed integral to said bottom portion such that said open bottom end is coincident with a bottom edge of said blade body when said urethane is cured.

12. The method of claim 11 wherein said step of forming an extrusion comprises forming said extrusion from aluminum.

13. The method of claim 11 wherein said step of embedding an indent in each sidewall comprises embedding a steel ball therein.

14. The method of claim 11 further comprising the step of coupling a pivoting handle on a bottom portion of an outer end of said blade body.

15. A method of forming a conveyor belt primary cleaning blade device configured for installation on a conveyor belt system, said method comprising:
forming an extrusion comprising a pair of opposing sidewalls having upper ends connected together by a top wall and an open bottom end and wherein said extrusion has first and second ends and wherein an indent is embedded in each sidewall to form a first pair of opposing indents at said first end and a second pair of opposing indents at said second end;
inserting said extrusion into a mold for forming a blade body having a cleaning edge and a bottom portion opposite said cleaning edge;
pouring a urethane into said mold to form said cleaning blade with said extrusion being formed integral to said bottom portion such that said open bottom end is coincident with a bottom edge of said blade body when said urethane is cured;
machining a groove track in an element that is fixed to a mounting tube configured for mounting within a conveyor belt system; and
sliding said open bottom end of said extrusion over said element such that any pair of said opposing indents are engaged within said groove track to releasably secure said blade body to said mounting tube.

16. The method of claim 15 wherein said step of forming an extrusion comprises forming said extrusion from aluminum.

17. The method of claim 15 wherein said step of embedding an indent in each sidewall comprises embedding a steel ball therein.

18. The method of claim 15 further comprising the step of coupling a pivoting handle to said bottom portion at an outer end of said blade body.

19. A method of forming a conveyor belt primary cleaning blade device configured for installation on a conveyor belt system, said method comprising:
forming an extrusion comprising a pair of opposing sidewalls having upper ends connected together by a top wall and an open bottom end and wherein said extrusion has first and second ends and wherein an indent is embedded in each sidewall to form a first pair of opposing indents at said first end and a second pair of opposing indents at said second end;
inserting said extrusion into a mold for forming a blade body having a cleaning edge and a bottom portion opposite said cleaning edge;
pouring a urethane into said mold to form said cleaning blade with said extrusion being formed integral to said bottom portion such that said open bottom end is coincident with a bottom edge of said blade body when said urethane is cured;
machining a groove track in an aluminum element that is fixed to a mounting tube configured for mounting within a conveyor belt system; and
applying a downward force on said blade body causing said open bottom end of said extrusion to press over said aluminum element such that any pair of said opposing indents are engaged with said groove track to releasably secure said blade body to said mounting tube.

20. The method of claim 19 further comprising the step of removing said blade body by applying an upward force on said blade body to disengage said opposing indents from said groove track.
